(19) United States
(12) Patent Application Publication
(10) Pub. No.: US 2005/0193324 A1
(43) Pub. Date: Sep. 1, 2005

(54) Method and apparatus for displaying embedded content in documents

(75) Inventor: Lance Jeffrey Purple, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/787,658

(22) Filed: Feb. 26, 2004

(51) Int. Cl. G06F 17/24

(52) U.S. Cl. 715/510

(57) ABSTRACT

The present invention provides a method, apparatus, and computer instructions for parsing the document to render the document in a display window in a data processing system. The element is sent to a set of applications in response to identifying that the element in the document cannot be rendered by the browser. An application is selected to render the element in response to receiving a response from one or more applications in the set of applications in which the response identifies the application as being capable of rendering the element. Thereafter, the application renders the element to display the document.

### BACKGROUND OF THE INVENTION

1. Technical Field

The present invention relates generally to an improved data processing system and in particular, to a method and apparatus for processing data. Still more particularly, the present invention provides a method, apparatus, and computer instructions for displaying content in a document.

2. Description of Related Art

The Internet is a global network of computers and networks joined together by means of gateways that handle data transfer and the conversion of messages from a protocol of the sending network to a protocol used by the receiving network. On the Internet, any computer may communicate with any other computer with information traveling over the Internet through a variety of languages, also referred to as protocols. The set of protocols used on the Internet is called transmission control protocol/Internet Protocol (TCP/IP).

The Internet has revolutionized both communications and commerce, as well as, being a source of both information and entertainment. For many users, email is a widely used format to communicate over the Internet. Additionally, the Internet is also used for real-time voice conversations.

With respect to transferring data over the Internet, the World Wide Web environment is used. This environment is also referred to simply as “the Web”. The Web is a mechanism used to access information over the Internet. In the Web environment, servers and clients effect data transaction using the hypertext transfer protocol (HTTP), a known protocol for handling the transfer of various data files, such as text files, graphic images, animation files, audio files, and video files.

On the Web, the information in various data files is formatted for presentation to a user by a standard page description language, the hypertext markup language (HTML). Documents using HTML are also referred to as Web pages. Web pages are connected to each other through links or hyperlinks. These links allow for a connection or link to other Web resources identified by a universal resource identifier (URI), such as a uniform resource locator (URL).

A browser is a program used to look at and interact with all of the information on the Web. A browser is able to display Web pages and to traverse links to other Web pages. Resources, such as Web pages, are retrieved by a browser, which is capable of submitting a request for the resource. This request typically includes an identifier, such as, for example, a URL. As used herein, a browser is an application used to navigate or view information or data in any distributed database, such as the Internet or the World Wide Web. A user may enter a domain name through a graphical user interface (GUI) for the browser to access a source of content. The domain name is automatically converted to the IP address by a domain name system (DNS), which is a service that translates the symbolic name entered by the user into an IP address by looking up the domain name in a database.

The browser includes a user interface, which is a GUI that allows the user to interface or communicate with another browser. This interface provides for selection of various functions through menus and allows for navigation. For example, a menu may allow a user to perform various functions, such as saving a file, opening a new window, displaying a history, and entering a URL.

In browsing documents, HTML statements in a document, such as a Web page, are processed by the browser for presentation on a display. In processing a Web page, the browser may encounter elements or objects containing data that the browser is unable to render on a display window. As used herein, the term “render” means to convert any coded content to the required format for display or printing. For example, a Web page is said to be “rendered” when the page is displayed. When an element that cannot be rendered by the browser is rendered, the browser may initiate execution of a plug-in, download, or install a plug-in to render the element. A plug-in is a program, separate from the browser, capable of rendering one or more data types in a portion of a window provided by the browser. The plug-in is selected based on metadata identified by parsing the element. This metadata may be the content type or a suggested name of a plug-in.

In some cases, this type of rendering by a browser selected plug-ins based on the browser examining the element is undesirable. Such a system may be undesirable in the event that the browser may be alleged to infringe on intellectual property. Some proposed alternatives to the current system include displaying a pop up dialogue; requiring user acknowledgement prior to execution of a plug-in; replacing external data references with encoded binary data placed directly in the document; and using JavaScript to dynamically alter the current Web page such that the user does not interact with plug-in controls.

These solutions, however, are not ideal. For example, the display of a pop-up dialog does not require changes to existing Web sites, but greatly inconveniences users. The replacement of external data references result in plug-ins not displaying at least a portion of an object external to the Web page. This system, however, requires extensive changes to existing Web sites and makes Web sites more difficult to maintain. The use of JavaScript also requires extensive changes to Web sites and does not work unless the browser supports JavaScript.

Therefore, it would be advantageous to have an improved method, apparatus, and computer instructions for managing the use of plug-ins to render elements without requiring the browser to use metadata or examine elements to select appropriate plug-ins to render the elements. Such a method also would free the browser of the need to understand the metadata for unknown data types or to associate the metadata with specific plug-ins.

### SUMMARY OF THE INVENTION

The present invention provides a method, apparatus, and computer instructions for parsing the document to render the document in a display window in a data processing system. The element is sent to a set of applications in response to identifying that the element in the document cannot be rendered by the browser. An application is selected to render the element in response to receiving a response from one or more applications in the set of applications in which the response identifies the application as being capable of rendering the element. Thereafter, the application renders the element to display the document.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A-4D are diagrams illustrating a process and data flow for rendering elements in a Web page in accordance with a preferred embodiment of the present invention;

FIG. 5 is a flowchart of a process for processing a Web page in accordance with a preferred embodiment of the present invention; and

FIG. 6 is a flowchart of a process for processing an element in a Web page in accordance with a preferred embodiment of the present invention.

### DETAILED DESCRIPTION OF THE PREFERRED EMBODIMENT

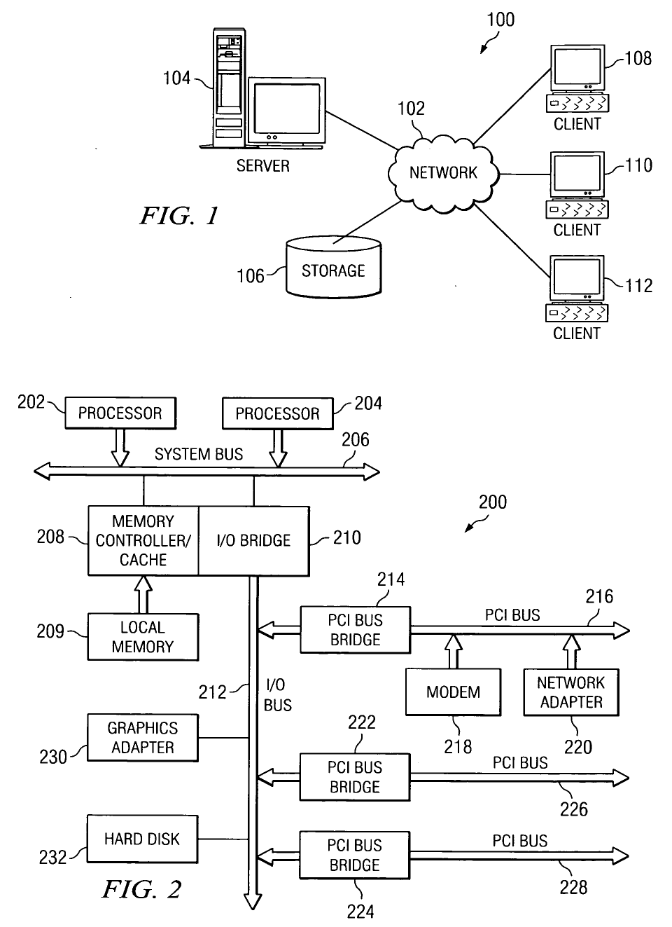

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

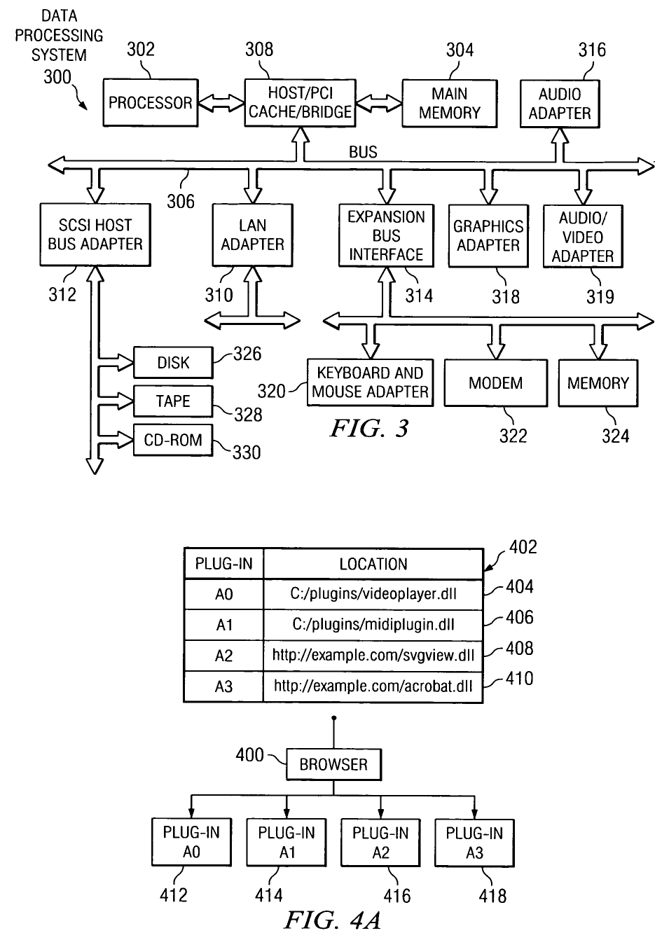

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Currently browsers executing a data processing system, such as data processing system 300, interact with plug-ins by parsing statements in documents, such as Web pages, to detect embedded content. This embedded content may be detected through indicators, such as <OBJECT> tags. The metadata of the embedded content is then examined to identify with the identified plug-in then being executed to render or display the embedded content.

In contrast, the present invention provides a method, apparatus, and computer instructions for displaying content in a document, such as a Web page. The browser executes one or more plug-ins prior to parsing or processing a Web page. A plug-in is a program that works with another program, such as a browser, to enhance its capability. Plug-ins are added to browsers to enable these programs to support new types of content, such as audio or video.

When embedded content is detected that cannot be rendered by the browser, this embedded content is sent to the plug-ins. Further, the browser does not examine any metadata in the embedded content. Each plug-in examines the embedded content and provides a response or indication as to whether the embedded content can be displayed. The browser then selects one of the plug-ins and then allows the selected plug-in to display the embedded content.

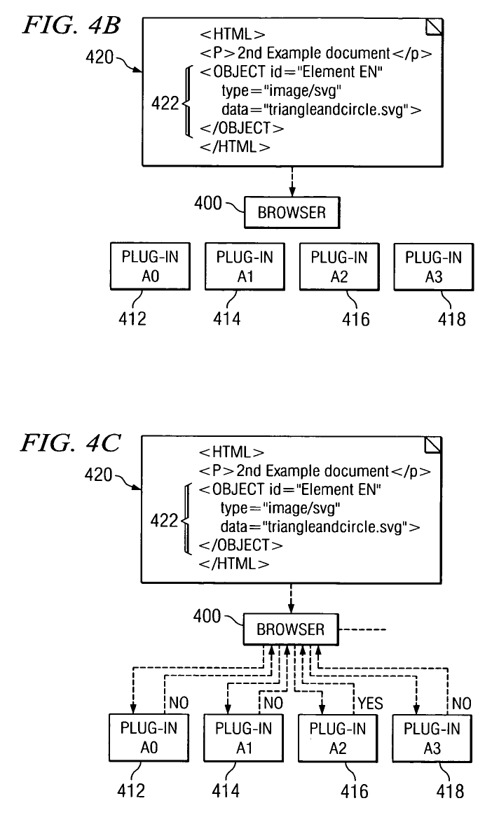

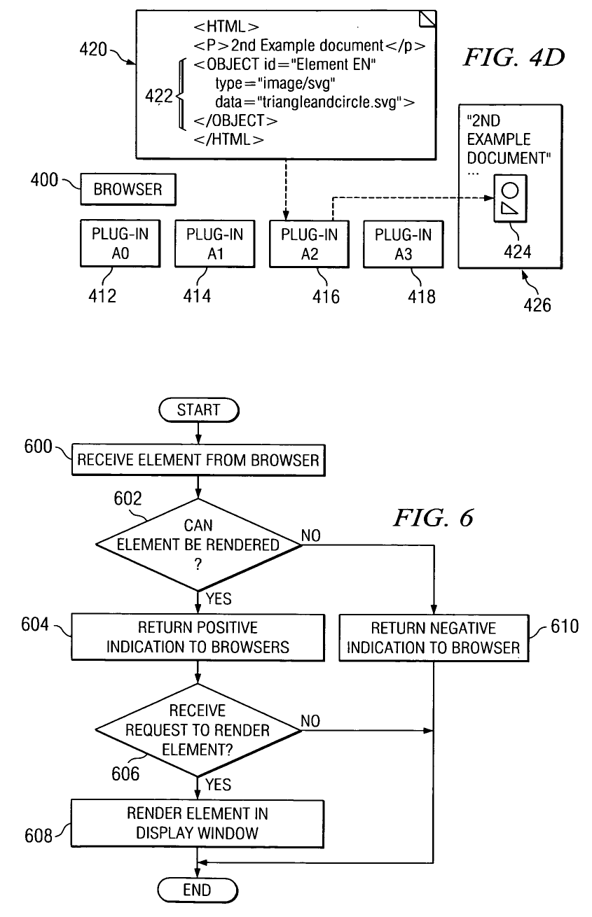

Turning now to FIGS. 4A-4D, diagrams illustrating a process and data flow for rendering elements in a Web page are depicted in accordance with a preferred embodiment of the present invention. In FIG. 4A, browser 400 is an example of a browser that may be used to display documents, such as Web pages containing HTML statements. The use of a browser in these examples is not meant to imply architectural limitations to the present invention. Presently available browsers may include additional functions not shown or may omit functions shown in a browser. A browser may be any application that is used to search for and display content on a distributed data processing system. Browser 400 may be implemented using known browser applications, such as Netscape Navigator or Microsoft Internet Explorer. Netscape Navigator is available from Netscape Communications Corporation while Microsoft Internet Explorer is available from Microsoft Corporation.

In this example, browser 400 identifies configured plug-ins from list 402. As shown, list 402 contains entries 404, 406, 408, and 410. Each entry includes an identification of a plug-in, as well as, a location of the plug-in. The plug-ins identified in these entries are ones that have been configured to be active in execution of browser 400. This list is used by browser 400 to initiate execution of plug-ins 412, 414, 416, and 418. Execution of these plug-ins is initiated prior to receiving a document for display. These plug-ins are used to render content, such as, for example, audio, images, text, and video. These plug-ins also may initiate execution of executable content such as Java or other applications.

In FIG. 4B, browser 400 receives a document, such as Web page 420. Browser 400 parses Web page 420 to render the document in a display window. In parsing Web page 420, an object, such as element 422, is identified as one that browser 400 is unable to render for display. Browser 400 does not parse element 422 or attempt to find metadata describing element 422 to select a plug-in to render this element. In these examples, browser 400 identifies an element as not being displayable when an element is identified as an embedded object or applet in Web page 420.

Instead, element 422 is passed to each of the plug-ins in FIG. 4C. Element 422 is passed to plug-ins 412, 414, 416, and 418 in succession in these illustrative embodiments. In response to receiving element 422, each of the plug-ins parse the received element using code that is separate from browser 400 to determine whether element 422 can be rendered. Each of the plug-ins returns a browser notification to browser 400. In these examples, element 412 returns a “no” notification, plug-in 414 returns a “no” notification, plug-in 416 returns a “yes” notification, plug-in 418 returns a “no” notification. If more than one plug-in returns a “yes” notification, browser 400 may choose any one of the plug-ins which returned “yes” (for example, the first or last such plug-in in the order in which the browser queried them).

When multiple plug-ins indicate that they can render an element, the plug-in may be selected in a number of different ways using different types of criteria. For example, numeric order may be used. In this type of implementation, the plug-ins are assigned a numeric order. If two plug-ins indicate that they can render element 422, then the first plug-in in the numeric order is selected for rendering element 422. In another illustrative implementation, the version number may be used to select the plug-in. In this case, a plug-in having a highest version number may be selected to render element 422. Alternatively, the date of the plug-in also may be used as a selection criteria. With a date, the plug-in with the most recent date may be selected for rendering element 422. Additionally, each plug-in may be assigned a weight for use in selecting the plug-in to render the elements. The plug-in with the highest weight value is selected in this type of system. These weights may be user assigned.

In FIG. 4D, browser 400 selects plug-in 416 to render element 422 in shared portion 424 in display window 426 to display Web page 420. In this manner, Web page 420 may be processed and displayed without requiring browser 400 to process or parse element 422 or to find metadata for element 422 to select a plug-in to display the element. This illustrative mechanism requires the plug-ins to parse element 422 or identify metadata describing element 422 to determine whether any of the plug-ins can render the element.

In the event that none of the plug-ins are able to render element 422, that element may be skipped. Alternatively, browser 400 may identify alternative text to display. This text may be, for example, an error message and may be identified by the tag for the element.

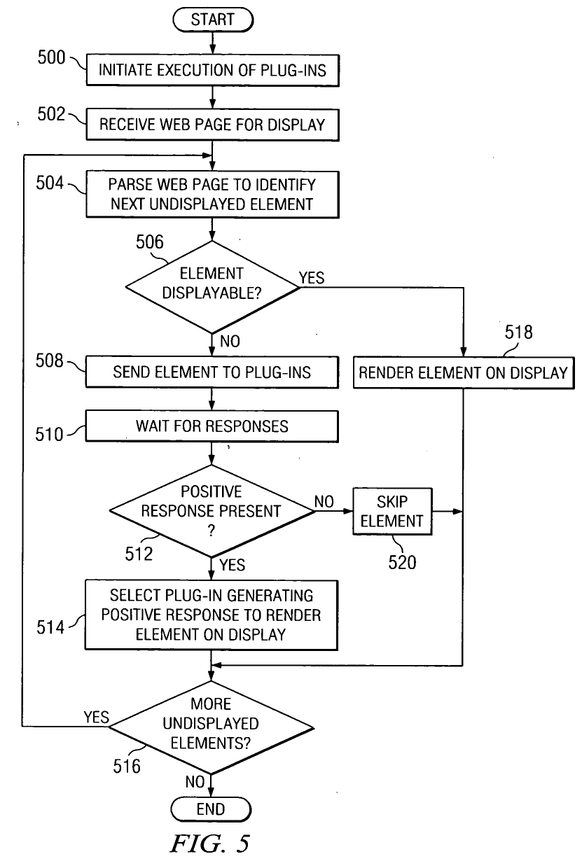

With reference now to FIG. 5, a flowchart of a process for processing a Web page is depicted in accordance with a preferred embodiment of the present invention. The process illustrated in FIG. 5 may be implemented in a browser, such as browser 400 in FIGS. 4A-4D.

The process begins by initiating execution of plug-ins (step 500). In these illustrative examples, the execution of plug-ins is initiated when the browser is run or executed. Next, a Web page is received for display (step 502). The receipt of the Web page may be initiated in a number of different ways. For example, the Web page may be retrieved by a user selecting a link on a currently displayed Web page or by the user entering an address or URL.

Then, the Web page is parsed to identify the next undisplayed element (step 504). Next, a determination is made as to whether the identified element is displayable by the browser (step 506). If the element is not displayable, then the element is sent to the plug-ins (step 508). Then, the process waits for responses (step 510).

Next, when responses are received, a determination is made as to whether a positive response is present (step 512). If a positive response is present, then the plug-in generating a positive response is selected to render element on display (step 514). If no positive response is present, the element is skipped (step 520). Next, a determination is made as to whether more undisplayed elements are present in the Web page (step 516). If more undisplayed elements are not present, the process then terminates. Otherwise the process proceeds to step 504.

Referring back to step 506 as described above, if the element is displayable, then the element is rendered on the display (step 518) with the process then proceeding to step 516. In step 516, if more undisplayed elements are present, then the process proceeds to step 504 as described above. Otherwise the process terminates.

With reference now to FIG. 6, a flowchart of a process for processing an element in a Web page is depicted in accordance with a preferred embodiment of the present invention. The process illustrated in FIG. 6 may be implemented in a plug-in, such as plug-in 412 in FIGS. 4A-4D.

The process begins by receiving an element from a browser (step 600). Next, a determination is made as to whether an element can be rendered (step 602). This determination is made using code that is separate than that for the browser. If the element can be rendered, then a positive indication is returned to the browser (step 604).

Next, a determination is made as to whether a request has been received to render element (step 606). If a request is received to render an element, then the element is rendered in a display window (step 608) with the process terminating thereafter.

Referring back to step 602, if an element can not be rendered, then a negative indication is returned to the browser (step 610) with the process terminating thereafter. In step 606, if a request is not received to render element, then the process terminates.

Thus, the present invention provides a method, apparatus, and computer instructions for processing documents. Specifically, the mechanism of the present invention allows for selection of a plug-in or other auxiliary application to render an element in a document for display when a browser is unable to render that element. This mechanism allows for the browser to select a plug-in to display the element without displaying or parsing the element and without looking for metadata describing the element. A determination of whether an element can be rendered by a particular plug-in is made by the plug-ins. The plug-ins return a response to the browser as to whether they can render the element. Based on this response, the browser selects one of the plug-ins to render the element.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMS, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a browser for displaying a document, the method comprising the computer implemented steps of:
parsing the document to render the document in a display window in a data processing system;
responsive to identifying an element in the document that cannot be rendered by the browser, sending the element to a set of applications; and
responsive to receiving a response from a particular application in the set of applications in which the response identifies the particular application as being capable of rendering the element, selecting the particular application to render the element, wherein the particular application renders the element to display the document.

2. The method of claim 1, wherein the set of applications are a set of plug-ins.

3. The method of claim 1 further comprising:
initiating execution of the set of applications prior to parsing the document.

4. The method of claim 3 further comprising:
identifying the set of application as applications that have been configured to be active during execution of the browser.

5. The method of claim 1, wherein the selecting step selects the particular application from the set of applications based on any criteria other than ones based on an examination of the element.

6. The method of claim 1, wherein the particular application renders the element in a shared portion of a display window.

7. The method of claim 1, wherein the particular application is one which renders audio, video, textual, executable, or image content.

8. The method of claim 1, wherein the document is a Web page.

9. The method of claim 8, wherein the Web page includes hypertext markup language document.

10. A method in a plug-in for rendering a Web page, the method comprising the computer implemented steps of:
responsive to receiving an element from a browser, determining whether the plug-in is capable of rendering the element;
responsive to the plug-in being capable of rendering the element, returning an indication that the plug-in is capable of rendering the element to the browser; and
responsive to a selection of the plug-in to render the element, rendering the element in a window in which a document containing the element is being rendered by the browser.

11. A browser for displaying a document, the browser comprising:
parsing means for parsing the document to render the document in a display window in a data processing system;
sending means, responsive to identifying an element in the document that cannot be rendered by the browser, for sending the element to a set of applications; and
selecting means, responsive to receiving a response from a particular application in the set of applications in which the response identifies the particular application as being capable of rendering the element, for selecting the particular application to render the element, wherein the particular application renders the element to display the document.

12. The data processing system of claim 11, wherein the set of applications are a set of plug-ins.

13. The data processing system of claim 11 further comprising:
initiating means for initiating execution of the set of applications prior to parsing the document.

14. The data processing system of claim 13 further comprising:
identifying means for identifying the set of application as applications that have been configured to be active during execution of the browser.

15. The data processing system of claim 11, wherein the selecting means selects the particular application from the set of applications based on any criteria other than ones based on an examination of the element.

16. The data processing system of claim 11, wherein the particular application renders the element in a shared portion of a display window.

17. A data processing system in a plug-in for rendering a Web page, the data processing system comprising the computer implemented means of:
determining means, responsive to receiving an element from a browser, for determining whether the plug-in is capable of rendering the element;
returning means, responsive to the plug-in being capable of rendering the element, for returning an indication that the plug-in is capable of rendering the element to the browser; and
rendering means, responsive to a selection of the plug-in to render the element, for rendering the element in a window in which a document containing the element is being rendered by the browser.

18. A computer program product in a computer readable medium in a browser for displaying a document, the computer program product comprising the computer implemented instructions of:
first instructions for parsing the document to render the document in a display window in a data processing system;
second instructions, responsive to identifying an element in the document that cannot be rendered by the browser, for sending the element to a set of applications; and
third instructions, responsive to receiving a response from a particular application in the set of applications in which the response identifies the particular application as being capable of rendering the element, for selecting the particular application to render the element, wherein the particular application renders the element to display the document.

19. The computer program product of claim 18, wherein the set of applications are a set of plug-ins.

20. The computer program product of claim 18 further comprising:
fourth instructions for initiating execution of the set of applications prior to parsing the document.

21. The computer program product of claim 20 further comprising:
fifth instructions for identifying the set of application as applications that have been configured to be active during execution of the browser.

22. The computer program product of claim 18, wherein the selecting instructions selects the particular application from the set of applications based on any criteria other than ones based on an examination of the element.

23. The computer program product of claim 18, wherein the particular application renders the element in a shared portion of a display window.

24. The computer program product of claim 18, wherein the particular application is one which renders audio, video, textual, executable, or image content.

25. The computer program product of claim 18, wherein the document is a Web page.

26. The computer program product of claim 25, wherein the Web page includes hypertext markup language document.

27. A computer program product in a computer readable medium in a plug-in for rendering a Web page, the computer program product comprising the computer implemented instructions of: first instructions, responsive to receiving an element from a browser, for determining whether the plug-in is capable of rendering the element;
second instructions, responsive to the plug-in being capable of rendering the element, for returning an indication that the plug-in is capable of rendering the element to the browser; and
third instructions, responsive to a selection of the plug-in to render the element, for rendering the element in a window in which a document containing the element is being rendered by the browser.

28. A data processing system comprising:
a bus system;
a memory connected to the bus system, wherein the memory includes a set of instructions; and
a processing unit connected to the bus system, wherein the processing unit executes the set of instructions to parse a document to render the document in a display window in the data processing system; send the element to a set of applications in response to identifying an element in the document that cannot be rendered by a browser; and select a particular application to render the element, wherein the particular application renders the element to display the document in response to receiving a response from the particular application in the set of applications in which the response identifies the particular application as being capable of rendering the element.

29. A data processing system comprising:
a bus system;
a memory connected to the bus system, wherein the memory includes a set of instructions; and
a processing unit connected to the bus system, wherein the processing unit executes the set of instructions to determine whether a plug-in is capable of rendering an element in response to receiving the element from a browser; return an indication that the plug-in is capable of rendering the element to the browser in response to the plug-in being capable of rendering the element; and render the element in a window in which a document containing the element is being rendered by the browser in response to a selection of the plug-in to render the element.
